(19) United States
(12) Patent Application Publication
(10) Pub. No.: US 2018/0184569 A1
(43) Pub. Date: Jul. 5, 2018

(54) A RADIAL FINGER TILLAGE DISC APPLIED TO CHAIN

(71) Applicant: Haidnay Innovation Company Pty Ltd, South Australia (AU)

(72) Inventor: Shane Peter KELLY, South Australia (AU)

(21) Appl. No.: 15/737,279

(22) PCT Filed: Jun. 16, 2016
(86) PCT No.: PCT/AU2016/000206

§ 371 Date: Dec. 16, 2017

(30) Foreign Application Priority Data
Jun. 16, 2015 (AU) 2015902282

(51) Int. Cl. A01B 23/06; A01B 35/16; A01B 35/28; A01B 33/02

(52) U.S. Cl. CPC A01B 23/06; A01B 33/024; A01B 35/28; A01B 35/16

(57) ABSTRACT

A tillage element of a tillage tool, comprising a first member being a plurality of circumferentially spaced radially extending finger elements, the tillage element further comprising a second member being a means for securing the first member to an elongate member, such that the circumferentially spaced radially extending finger elements are secured in relation to and around the elongate member.

### PRIORITY DOCUMENTS

The present application claims priority from Australian Provisional Patent Application No. 2015902282 titled “A RADIAL FINGER TILLAGE DISC APPLIED TO CHAIN” and filed on 16 Jun. 2015, the content of which is hereby incorporated by reference in its entirety.

### INCORPORATION BY REFERENCE

The following publications are referred to in the present application and their contents are hereby incorporated by reference in their entirety:

Australian Patent Application No. AU2007216912 titled “AN AGRICULTURAL GROUND ENGAGING CHAIN AND AN AGRICULTURAL IMPLEMENT” in the name of Haidnay Pty Ltd.

### TECHNICAL FIELD

The present invention relates to a tillage arrangement applied to a chain. In one form, the present invention relates to a radial finger tillage disc applied to a chain for the purposes of tilling soil.

### BACKGROUND

Farmed land by its nature undergoes cyclic periods of sowing, growth, and harvest. Sowing, growing and harvesting of crops all require conditioning of the soil if successful returns are to be obtained from the worked area. The condition of a farmed area after harvest does not normally provide ideal conditions in which further crops can be sowed. When the main crop is harvested the soil often includes weeds that need to be destroyed as well as stubble and the like from previous crops requiring uprooting and cutting before any seed can be sowed.

Not only does stubble require uprooting or cutting and weeds still need to be eradicated, but there is also the further requirement of having the soil leveled such that sowing implements responsible for reintroducing a new crop into the field can do so efficiently and expeditiously.

There is also the need for being able to produce large, consistent soil particle sizes which are less likely to erode in wind or water flow, and it is desirable that any tilling operations are able to prepare a seedbed in a single pass.

This invention provides improvements to known agricultural implements such as those disclosed in AU2007216912, that seek to address the above referenced problems.

It is against this background and the problems and difficulties associated herewith that the present invention has been developed.

Certain objects and advantages of the present invention will become apparent from the following description, taken in connection with the accompanying drawings, wherein, by way of illustration and example, an embodiment of the present invention is disclosed.

### SUMMARY

According to a first aspect of the present invention, there is provided a tillage element of a tillage tool, comprising a first member being a plurality of circumferentially spaced radially extending finger elements, the tillage element further comprising a second member being a means for securing the first member to an elongate member, such that the circumferentially spaced radially extending finger elements are secured in relation to and around the elongate member.

In one form, the plurality of circumferentially spaced radially extending finger elements are evenly spaced apart from each other.

In one form, the second member is a disc which is secured to both the first member and the elongate member.

In one form, the plurality of circumferentially spaced radially extending finger elements are of the same length.

In one form, the disc is secured to the elongate member such that it is generally orthogonal to the direction of elongation of the elongate member.

In one form, the first member and second member are formed as a single body.

In one form, the elongate member is a chain or chain-like, comprising a plurality of interconnected chain or chain-like link elements.

### BRIEF DESCRIPTION OF DRAWINGS

Embodiments of the present invention will be discussed with reference to the accompanying drawings wherein:

FIG. 1 is a plan view of a flat radial finger tillage disc according to an embodiment of the invention;

FIG. 2 is a perspective view of the flat radial finger tillage disc of FIG. 1;

FIG. 3 is a plan view of a dished radial finger tillage disc according to another embodiment of the invention;

FIG. 4 is a perspective view of the dished radial finger tillage disc of FIG. 3;

FIG. 5 is an exploded view of the flat radial finger tillage disc and chain link of FIG. 1;

FIG. 6 is a perspective view of a tillage tool with a plurality of flat radial finger tillage discs;

FIG. 7 is an alternative perspective view of a tillage tool with a plurality of flat radial finger tillage discs;

FIG. 8 is a plan view of the tillage tool of FIG. 7;

FIG. 9 is an exploded view of the dished radial finger tillage disc and chain link of FIG. 3;

FIG. 10 is a perspective view of a tillage tool with a plurality of dished radial finger tillage discs;

FIG. 11 is an alternative perspective view of a tillage tool with a plurality of dished radial finger tillage discs;

FIG. 12 is a plan view of the tillage tool of FIG. 11; and

FIG. 13 is a perspective view of an agricultural implement incorporating a plurality of tillage tools.

In the following description, like reference characters designate like or corresponding parts throughout the figures.

### DESCRIPTION OF EMBODIMENTS

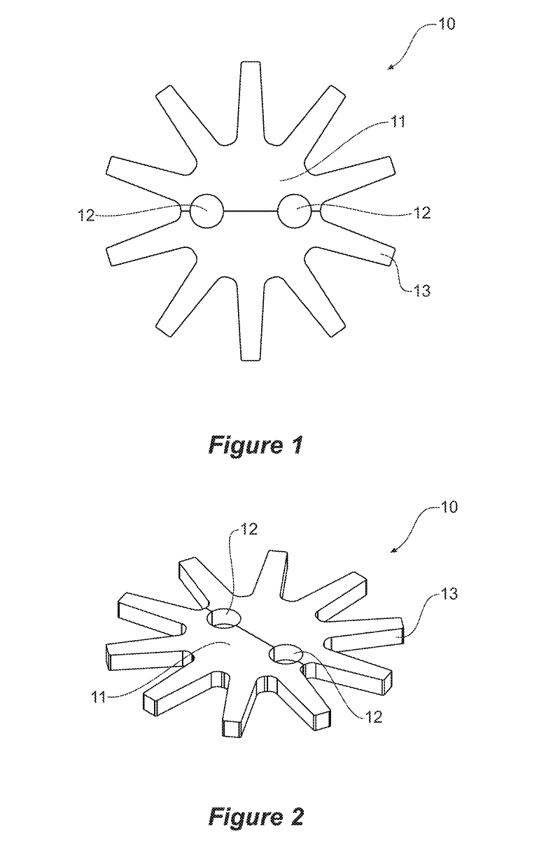

Referring now to FIGS. 1 and 2, where there is shown a flat radial finger tillage disc 10, according to an embodiment. The disc 10 features a centre section 11 which features two chain link holes 12 for securing the centre section 11 to a chain link (not shown). Extending from the centre section 11 are a number of evenly spaced apart finger elements 13, which extend radially from the centre of the disc 10 and in plane with the centre section 11.

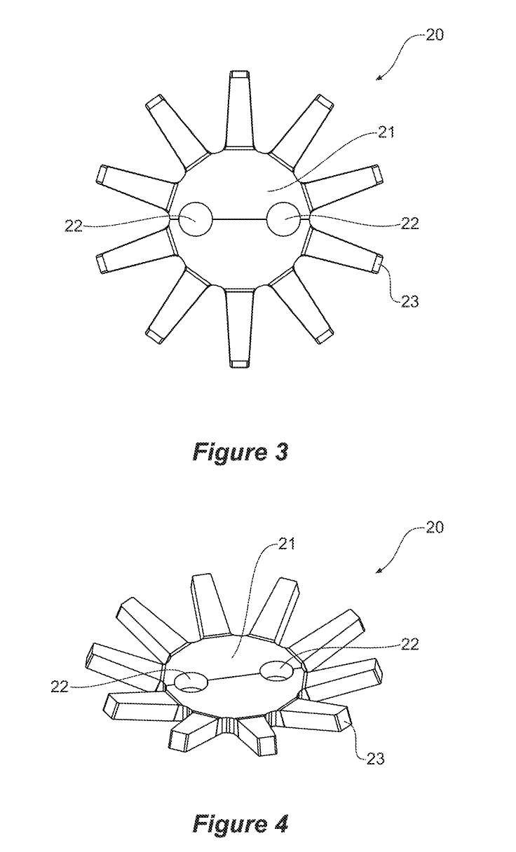

Referring now to FIGS. 3 and 4, where there is shown a dished radial finger tillage disc 20, according to another embodiment. The disc 20 features a centre section 21 which features two chain link holes 22 for securing the centre section 21 to a chain link (not shown). Extending from the centre section 21 are a number of evenly spaced apart finger elements 23, which extend radially from the centre of the disc 20 and are at an angle to the centre section 21, such that the overall profile of the disc 20 is dished.

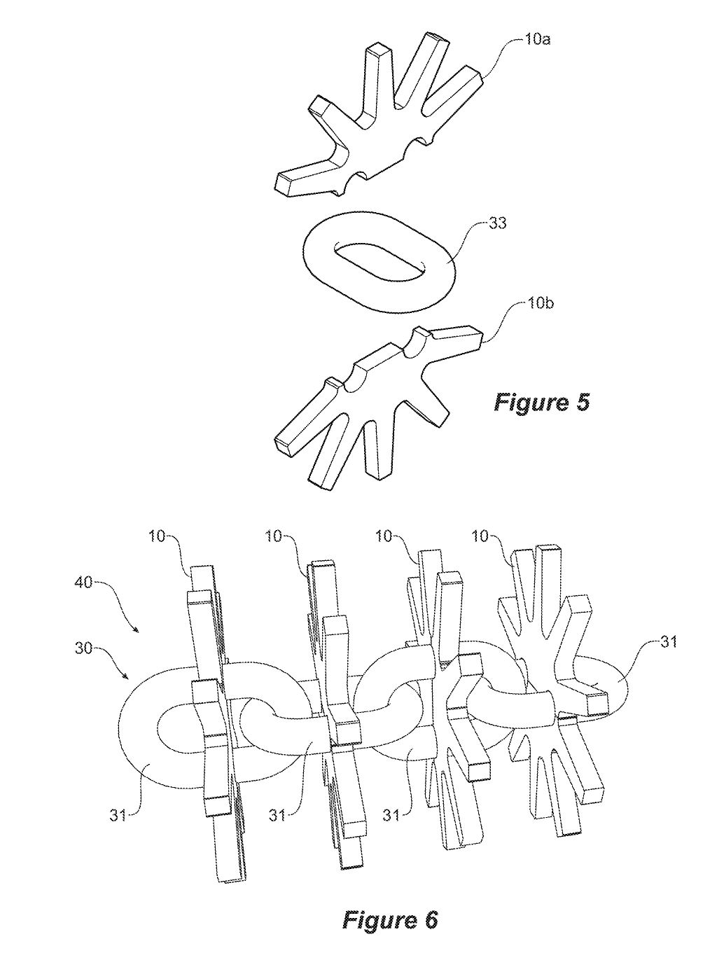

Referring now to FIG. 5, where there is shown an exploded assembly drawing of the flat radial finger tillage disc 10 and a chain link 31. The disc 10 is manufactured by pressing sheet metal into a disc shape incorporating the radial finger elements, where it is then cut symmetrically in two halves 10a and 10b, where thereinafter the two halves 10a and 10b are then welded onto links 31.

The flat radial finger tillage disc 10 or the dished radial finger tillage disc 20 may be manufactured using sheet metal and a cutting process such as water jet, laser cutting or machining, or alternatively they may be cast or forged.

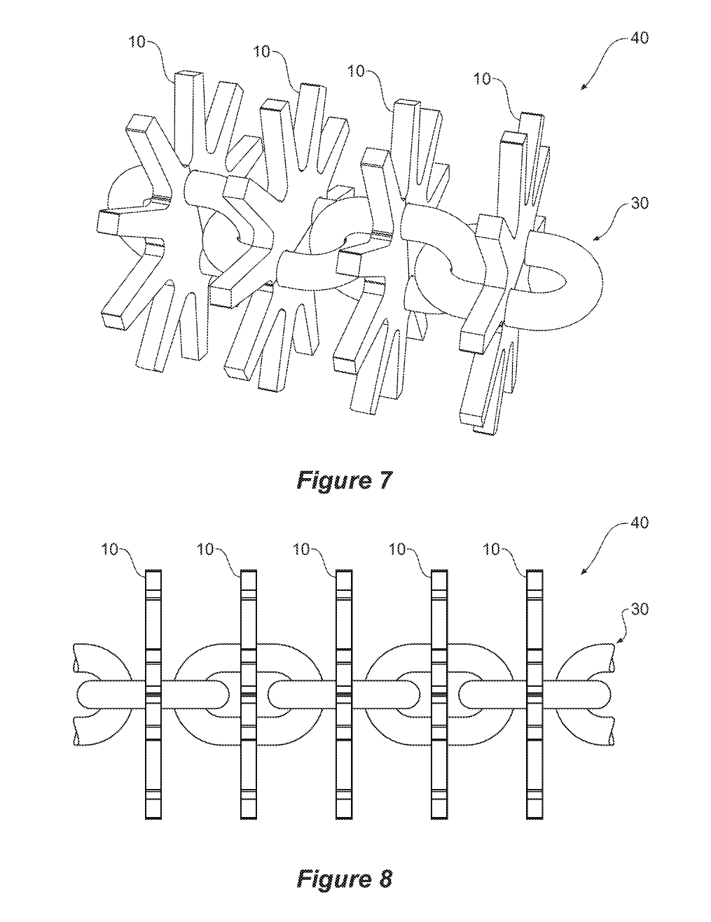

Referring now to FIGS. 6 to 8, which shows a tillage tool 40 comprising a chain 30 made up of individual chain links 31, which are preferably movable relative to one another. The radial finger tillage disc 10 may be coupled to every link 31, to approximately every second link 31, or otherwise as appropriate.

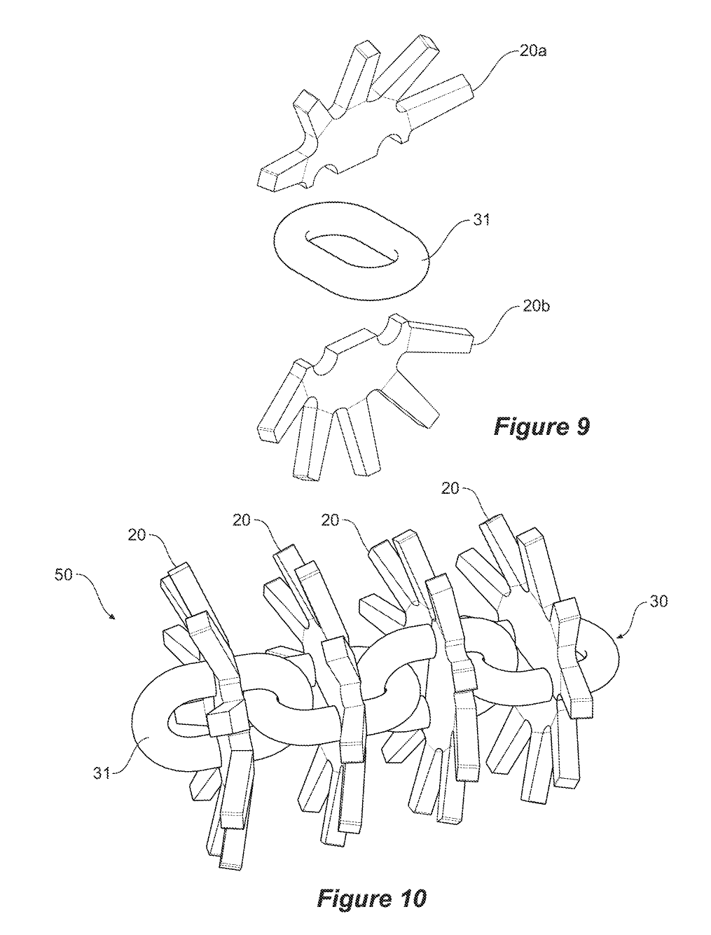

Referring now to FIG. 9, where there is shown an exploded assembly drawing of the dished radial finger tillage disc 20 and a chain link 31. The disc 20 is manufactured by pressing sheet metal into a dished disc shape incorporating the radially extending finger elements, where it is then cut symmetrically in two halves 20a and 20b, where thereinafter the two halves 20a and 20b are then welded onto links 31.

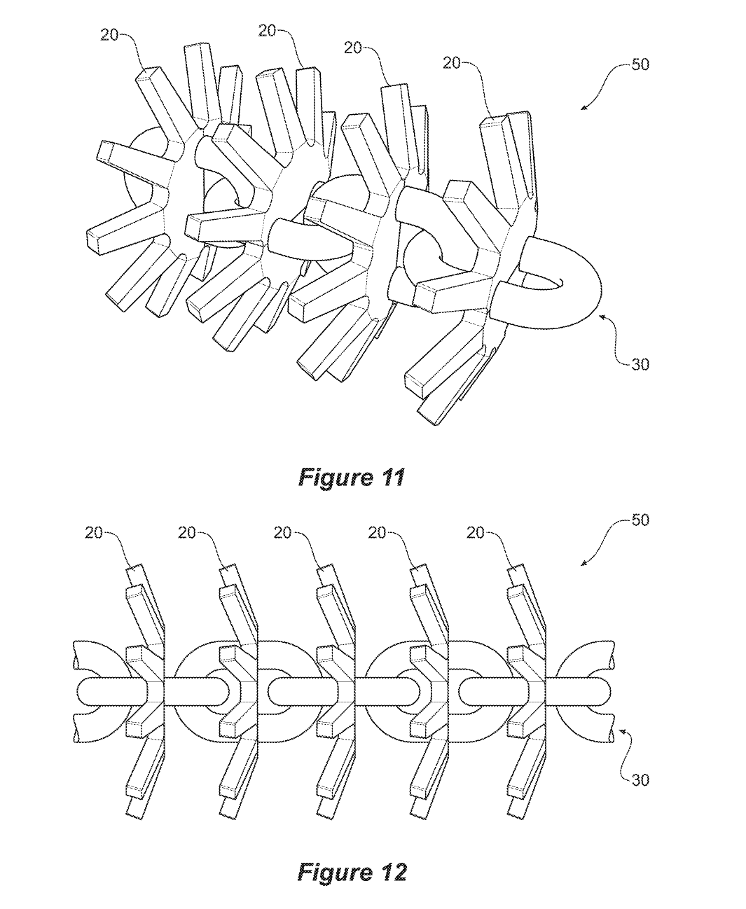

Referring now to FIGS. 10 to 11, which shows a tillage tool 50 comprising a chain 30 made up of individual chain links 31, which are preferably movable relative to one another. The dished radial finger tillage disc 20 may be coupled to every link 31, to approximately every second link 31, or otherwise as appropriate.

When a ground engaging vehicle, such as a tractor pulls the chain 30 along a farming field, the individual links 31 are adapted so as to be rotatable about the direction of elongation of the chain, such that the dished discs are able to till the soil by being able to level the surface through resettling of the top soil, rather than the dragging thereof, penetrate the soil such as to dislodge and cut off any weeds and also at the same time if required break up or uproot stubble that may be on the top surface.

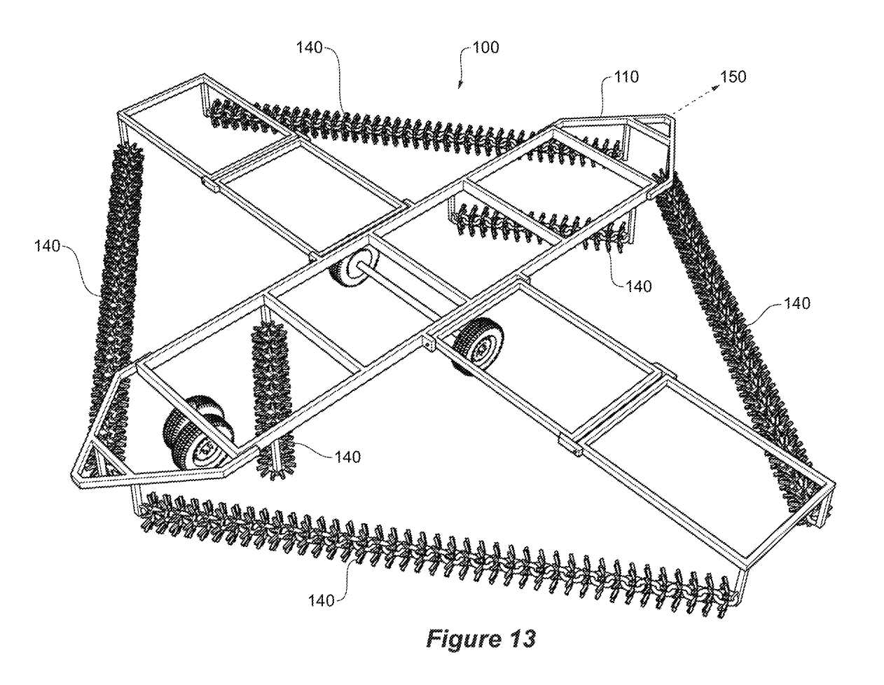

Referring now to FIG. 13, which shows an agricultural implement as disclosed in AU2007216912, which includes a frame 110 and a plurality of tillage tools 140. The agricultural implement 100 would be pulled by a ground engaging vehicle in the direction of travel 150 shown.

The tillage tool 140 can be configured in either a trailing or leading configuration. When in a trailing configuration, the tool is pulled such that the convex sides of the dished discs 20 are at an angle away from the direction of travel of the ground engaging vehicle. When in a leading configuration, the chain is pulled such that the convex sides of the dished discs 20 are at an angle towards the direction of travel of the ground engaging vehicle. As can be seen in FIG. 13, this configuration shows the plurality of tillage tools 140 in a leading configuration.

By virtue of the dished disc arrangement of the links, the action is carried out such that material is allowed to pass through the working chain rather than being dragged along as one would expect from conventional pulling of a chain across a surface or running a series of spikes perpendicular to the area of land being worked.

Further, by virtue of the angled radially extending finger elements 23, the dished disc 20 has a self-cleaning action which reduces the wrapping of stubble and weed residue around the implement when in a trailing configuration, and has a more aggressive action for greater soil penetration and agitation when in a leading configuration.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

For instance, the use of a chain to connect the radial finger tillage discs together in series, could equally be achieved using a series of chain-like links, loop and hook links as disclosed in AU2007216912 or any other flexible load bearing member such as a cable. Additionally, it is appreciated that the radial fingers can be provided in a variety of different profiles, such as square profiles when cut from a single plate for enhanced longevity and soil levelling properties, or rounded profiles from a forging process for greater penetration of the soil and improved self-cleaning properties of the discs.

1. A tillage element of a tillage tool, comprising a first member being a plurality of circumferentially spaced radially extending finger elements, the tillage element further comprising a second member being a means for securing the first member to an elongate member, such that the circumferentially spaced radially extending finger elements are secured in relation to and around the elongate member.

2. The tillage element of claim 1, wherein the plurality of circumferentially spaced radially extending finger elements are evenly spaced apart from each other.

3. The tillage element of claim 2, wherein the second member is a disc which is secured to both the first member and the elongate member.

4. The tillage element of claim 1, wherein the plurality of circumferentially spaced radially extending finger elements are of the same length.

5. The tillage element of claim 3, wherein the disc is secured to the elongate member such that it is generally orthogonal to the direction of elongation of the elongate member.

6. The tillage element of claim 1, wherein the first member and second member are formed as a single body.

7. A tillage element of a tillage tool, comprising:
a generally planar centre section featuring two chain link holes for securing the centre section to a chain link; and
a plurality of evenly spaced apart finger elements which extend radially from the centre of the tillage element.

8. The tillage element of claim 7, wherein the plurality of evenly spaced apart finger elements extend from the centre of the tillage element at an angle in plane with the centre section.

9. The tillage element of claim 7, wherein the plurality of evenly spaced apart finger elements extend from the centre of the tillage element at an angle out of plane with the centre section.

10. The tillage element of claim 7, wherein the centre section comprises a first half and a second half, such that the first and second half can be joined together over a chain link.

11. The tillage element of claim 7 wherein the tillage tool comprising a plurality of tillage elements, where the plurality of tillage elements are secured along the length of an elongate member.

12. The tillage tool of claim 7, wherein the elongate member is a chain or chain-like, comprising a plurality of interconnected chain or chain-like link elements.

13. The tillage element of claim 7 wherein the tillage tool comprising a plurality of tillage elements, where the plurality of tillage elements are secured along the length of an elongate chain or chain-like member, comprising a plurality of interconnected chain or chain-like link elements.

14. The tillage tool of claim 12, wherein a tillage element is secured to every link element.

15. The tillage tool of claim 12, wherein a tillage element is secured to every second link element.

16. The tillage tool of claim 12, wherein a tillage element is secured to every third link element.

17. (canceled)

18. (canceled)
